(19) United States
(12) Patent Application Publication
(10) Pub. No.: US 2026/0155587 A1
(43) Pub. Date: Jun. 4, 2026

(54) ELECTRICAL WIRING DEVICE HAVING A TOOLLESS INSTALLATION AND REMOVAL STRUCTURE

(71) Applicant: Pass & Seymour, Inc., Syracuse, NY (US)

(72) Inventors: Harold Watkins, Chittenango, NY (US); Miguel Castaneda, Syracuse, NY (US)

(73) Assignee: Pass & Seymour, Inc., Syracuse, NY (US)

(21) Appl. No.: 19/407,335

(22) Filed: Dec. 3, 2025

Related U.S. Application Data
(60) Provisional application No. 63/727,500, filed on Dec. 3, 2024.
(60) Provisional application No. 63/780,946, filed on Mar. 31, 2025.

(51) Int. Cl. H01R 4/48; H01R 43/26

(52) U.S. Cl. CPC H01R 4/48; H01R 43/26

(57) ABSTRACT

An electrical wiring device having speed install levers allowing for quick and safe installation of wires in the device. The speed install includes a lever paired with a wire retainer. As the lever is rotated from the initial closed position to an open position, the wire retainer is compressed to release/accept a wire therein. Utilizing levers and wire retainers allows for replacement of the electrical wiring device within a wall box or other location within a building without tools in an efficient and safe manner.

### FIELD OF THE INVENTION

The present invention relates generally to electrical wiring devices, and particularly to electrical wiring devices structured and configured to allow a user to quickly install and/or remove and replace an electrical wiring device.

### BACKGROUND

In conventionally installed electrical wiring devices, wires are inserted into the terminals of the electrical wiring device and held in position by screws prior to installation of the device into a wall box, for example.

Description of the Related Art Section Disclaimer: To the extent that specific patents/publications/products are discussed above in this Background Section or elsewhere in this Application, these discussions should not be taken as an admission that the discussed patents/publications/products are prior art for patent law purposes. For example, some or all of the discussed patents/publications/products may not be sufficiently early in time, may not reflect subject matter developed early enough in time and/or may not be sufficiently enabling so as to amount to prior art for patent law purposes. To the extent that specific patents/publications/products are discussed above in this Background Section and/or throughout the application, the descriptions/disclosures of which are all hereby incorporated by reference into this document in their respective entirety(ies).

### SUMMARY

The inventors of the present disclosure recognize that there are problems and limitations with conventional electrical wiring devices and related methods/processes of installation and removal thereof from a wall box or other location within a building. For example, replacing a conventional electrical wiring device takes a degree of skill, consideration and observance of significant safety protocols, and time to perform the task. Users must remove the electrical wiring device from the wall box and loosen or remove the screws holding the wires in place in the device. During this process, there are numerous safety considerations for handling the wires, screws, and related tools.

Thus, there is a need for an improved electrical wiring device that is structured and configured to allow a user to quickly and safely install and/or remove and replace the electrical wiring device.

It is therefore a principal object and advantage of the present disclosure to provide an electrical wiring device that eliminates one or more of the problems/issues associated with conventional devices and fulfill the need(s) identified above. A particular non-limiting goal of the utilization of the embodiments and implementations herein is to provide an electrical wiring device that is structured and configured to allow a user to quickly and safely install and/or remove and replace (and/or connect and disconnect from hot/neutral, line and load wires) the electrical wiring device. Such a “speed install” for an electrical wiring device would allow for fast and safe replacement with less skill required.

Embodiments of an electrical wiring device described and illustrated herein can be dynamic, and have components that are structured and configured to move between an open, wire unlocked and removing/receiving position/configuration; and a closed, wire received/removed and locked position/configuration; and have components that move with respect to other components,

The various examples described in this disclosure can be combined in any technical way possible, as should be understood by a person of ordinary skill in the art in conjunction with a review of this disclosure.

According to an embodiment, an electrical wiring device is provided that includes a housing having an inner compartment and at least one face. At least one lever moveable between a closed position and configuration and an open position and configuration can be disposed on the face of the housing outside of the inner compartment (but can be located inside, fully or partially, the inner compartment). The lever can be hingedly connected to the housing to allow rotation from the closed position and configuration to the open position and configuration. The electrical wiring device can have a wire retainer inside the inner compartment (but can be located inside, fully or partially, the inner compartment) in an initial neutral position.

In an example, the lever can be configured to rotate on a hinge from the closed position and configuration to an open position and configuration.

In an example, the wire retainer can be actuated from an initial neutral position/configuration to a compressed position/configuration when the lever is rotated to an open position/configuration.

In an example, the wire retainer can be configured to hold a wire stationary while in the neutral position/configuration.

In an example, the wire retainer can be sized and shaped to allow a wire to pass through an opening in the wire retainer while in the compressed position/configuration.

In an example, the lever can be a ground lever.

In an example, the lever can be a neutral lever.

In an example, the lever can include a hinge and a protrusion.

In an example, the protrusion can be sized and shaped to engage a wire retainer.

In an example, the wire retainer can be a continuously bent member. The bent member can have an opening on one end and a protrusion on the opposing end. The protrusion can be sized and shaped to fit within the opening.

In an example, the end of the wire retainer with the opening can be configured to translate across the opposing end with the protrusion.

In an example, the wire retainer can be made of high yield spring steel.

Electrical wiring device as used herein can mean, for example, GFCIs, AFCIs, switches, receptacle and non-receptacle—e.g., Pin and sleeve—products, as should be understood by a person of ordinary skill in the art in conjunction with a review of this disclosure.

The components/portions of the device according to an embodiment can be integrally formed as one molded or monolithic piece, or can have portions/components that are sealed, snapped, screwed, riveted, connected via a hinge or otherwise during the manufacturing process. The components/portions of the device according to an embodiment can be made from a plastic/polymer and/or metal, as should be understood by a person of ordinary skill in the art in conjunction with this disclosure. The components/portions can have rectangular, circular or other shaped cross sections, as should be understood by a person of ordinary skill in the art in conjunction with this disclosure.

### BRIEF DESCRIPTION OF THE DRAWINGS

FIG. 1 depicts a front perspective view of an exemplary electrical wiring device, according to an embodiment;

FIG. 2 depicts a rear perspective view of an exemplary electrical wiring device, according to an embodiment;

FIG. 3A depicts a side view of an exemplary electrical wiring device, according to an embodiment;

FIG. 3B depicts a side view of an exemplary electrical wiring device, according to an embodiment;

FIG. 4A depicts a side perspective view of an exemplary electrical wiring device, according to an embodiment;

FIG. 4B depicts a side perspective view of an exemplary electrical wiring device, according to an embodiment;

FIG. 5 depicts a cutaway front view (with the front portion of the housing removed) of an exemplary electrical wiring device, according to an embodiment;

FIG. 6 depicts a cutaway back view (with the back portion of the housing removed) of an exemplary electrical wiring device, according to an embodiment;

FIG. 7A depicts a close-up cutaway view of a lever and wire retainer, according to an embodiment;

FIG. 7B is a close-up cutaway view of a lever and wire retainer, according to an embodiment;

FIG. 7C is a close-up cutaway view of a lever and wire retainer, according to an embodiment;

FIG. 7D is a close-up cutaway view of a lever and wire retainer, according to an embodiment;

FIG. 8 depicts a cutaway side view of a lever and wire retainer, according to an embodiment;

FIG. 9 depicts an exemplary wire retainer, according to an embodiment;

FIG. 10A depicts a view of an exemplary lever, according to an embodiment;

FIG. 10B depicts a view of an exemplary lever, according to an embodiment;

FIG. 11A depicts a view of an exemplary ground lever, according to an embodiment; and

FIG. 11B depicts a view of an exemplary ground lever, according to an embodiment.

FIG. 12A depicts a close-up view of an exemplary lever, according to an alternative embodiment.

FIG. 12B depicts a close-up view of an exemplary lever, according to an alternative embodiment.

FIG. 12C depicts a close-up view of an exemplary lever, according to an alternative embodiment.

FIG. 13A depicts a close-up view of an exemplary lever, according to an alternative embodiment.

FIG. 13B depicts a close-up view of an exemplary lever, according to an alternative embodiment.

FIG. 13C depicts a close-up view of an exemplary lever, according to an alternative embodiment.

FIG. 14A depicts a close-up view of an exemplary lever, according to an alternative embodiment.

FIG. 14B depicts a close-up view of an exemplary lever, according to an alternative embodiment.

FIG. 14C depicts a close-up view of an exemplary lever, according to an alternative embodiment.

FIG. 14D depicts a close-up view of an exemplary lever, according to an alternative embodiment.

FIG. 15A depicts a close-up view of an exemplary lever, according to an alternative embodiment.

FIG. 15B depicts a close-up view of an exemplary lever, according to an alternative embodiment.

FIG. 15C depicts a close-up view of an exemplary lever, according to an alternative embodiment.

FIG. 15D depicts a close-up view of an exemplary lever, according to an alternative embodiment.

FIG. 16A depicts a close-up view of an exemplary lever, according to an alternative embodiment.

FIG. 16B depicts a close-up view of an exemplary lever, according to an alternative embodiment.

FIG. 16C depicts a close-up view of an exemplary lever, according to an alternative embodiment.

FIG. 16D depicts a close-up view of an exemplary lever, according to an alternative embodiment.

FIG. 17A depicts a perspective view of an exemplary lever on the electrical wiring device, according to an alternative embodiment.

FIG. 17B depicts a close-up view of an exemplary lever, according to an alternative embodiment.

FIG. 17C depicts a close-up view of an exemplary lever, according to an alternative embodiment.

FIG. 17D depicts a close-up view of an exemplary lever, according to an alternative embodiment.

FIG. 18A depicts a perspective view of an exemplary lever on the electrical wiring device, according to an alternative embodiment.

FIG. 18B depicts a close-up view of an exemplary lever, according to an alternative embodiment.

FIG. 18C depicts a close-up view of an exemplary lever, according to an alternative embodiment.

FIG. 18D depicts a close-up view of an exemplary lever, according to an alternative embodiment.

FIG. 19A depicts a perspective view of an exemplary neutral lever on the electrical wiring device, according to an alternative embodiment.

FIG. 19B depicts a perspective exploded view of the exemplary neutral lever and electrical wiring device shown in FIG. 19A, according to an alternative embodiment.

FIG. 19C depicts a close up view of the exemplary neutral lever shown in FIGS. 19A and 19B, according to an alternative embodiment.

FIG. 20A depicts a perspective view of a wire retainer, according to an alternative embodiment.

FIG. 20B depicts a bottom view of the wire retainer shown in FIG. 20A, according to an alternative embodiment.

FIG. 21A depicts a perspective view of a wire retainer, according to an alternative embodiment.

FIG. 21B depicts a bottom view of the wire retainer shown in FIG. 21A, according to an alternative embodiment.

### DETAILED DESCRIPTION

Aspects of the present embodiments and certain features, advantages, and details thereof, are explained more fully below with reference to the non-limiting examples illustrated in the accompanying drawings. Descriptions of well-known structures are omitted so as not to unnecessarily obscure embodiments in detail. It should be understood, however, that the detailed description and the specific non-limiting examples, while indicating aspects of the embodiments, are given by way of illustration only, and are not by way of limitation. Various substitutions, modifications, additions, and/or arrangements, within the spirit and/or scope of the underlying inventive concepts will be apparent to those skilled in the art from this disclosure.

While embodiments of the present disclosure have been particularly shown and described with reference to certain exemplary embodiments, it will be understood by one skilled in the art that various changes in detail may be affected therein without departing from the spirit and scope of the invention as defined by claims that can be supported by the written description and drawings. Further, where exemplary embodiments are described with reference to a certain number of elements it will be understood that the exemplary embodiments can be practiced utilizing either less than or more than the certain number of elements. If elements shown in a particular Figure discussed below are not specifically identified with respect to that Figure, the elements should be sufficiently identified with respect to at least one other Figure.

Reference will now be made in detail to the present exemplary embodiments of the invention, examples of which are illustrated in the accompanying drawings. Wherever possible, the same reference numbers will be used throughout the drawings to refer to the same or like parts. Discussion or illustration of a particular element or structural configuration does not mean that that particular element or structural configuration is required.

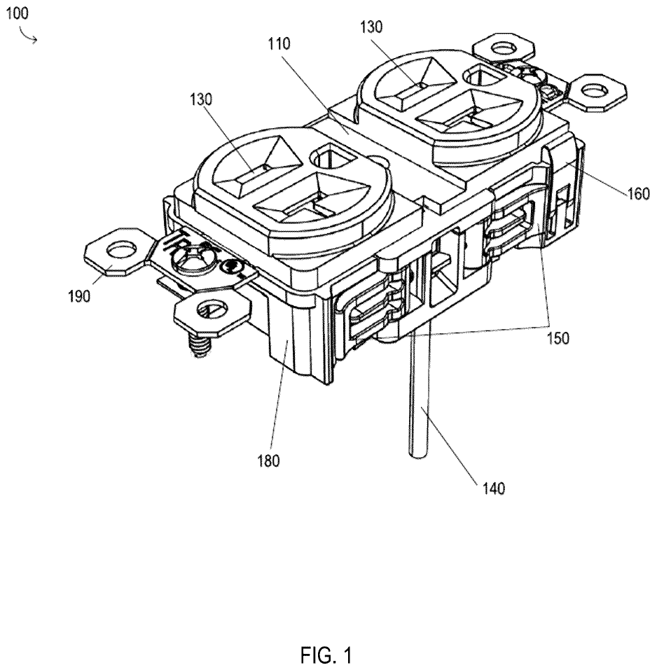

Referring now to the figures, FIG. 1 depicts an exemplary electrical wiring device 100 having speed install levers 150, 160 which provide for quick installation and replacement of the electrical wiring device 100. The electrical wiring device 100 can also include one or more conventional features to allow for retrofit into existing installations (as should be understood by a person of ordinary skill in the art in conjunction with a review of this disclosure). For example, the electrical wiring device 100 can include one or more outlet receptacles 130, a cover 110, and a ground strap 190 for installation.

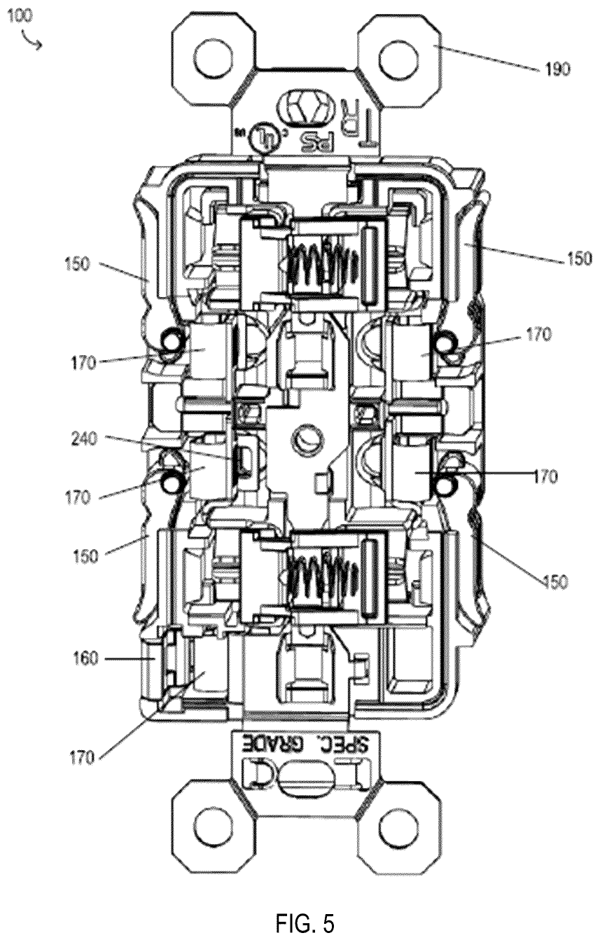

In an exemplary embodiment, the electrical wiring device 100 can have two neutral levers and two hot levers 150, and one ground lever 160 (see FIG. 5), though any suitable combination of neutral/hot levers 150 and ground levers 160 may be used. The levers 150, 160 can be situated on a housing 180, separate from the outlet receptacles 130, cover 110, and strap 190, though in some embodiments the electrical wiring device may be fabricated as a single piece or in any suitable combination of parts. In this exemplary embodiment, the levers are positioned on the sides of the housing.

A wire 140 (line/load, hot/neutral) can be inserted into the back of the housing 180 and held in place in the electrical wiring device by wire retainers 170 actuated by the levers 150, 160 (as shown in FIG. 5).

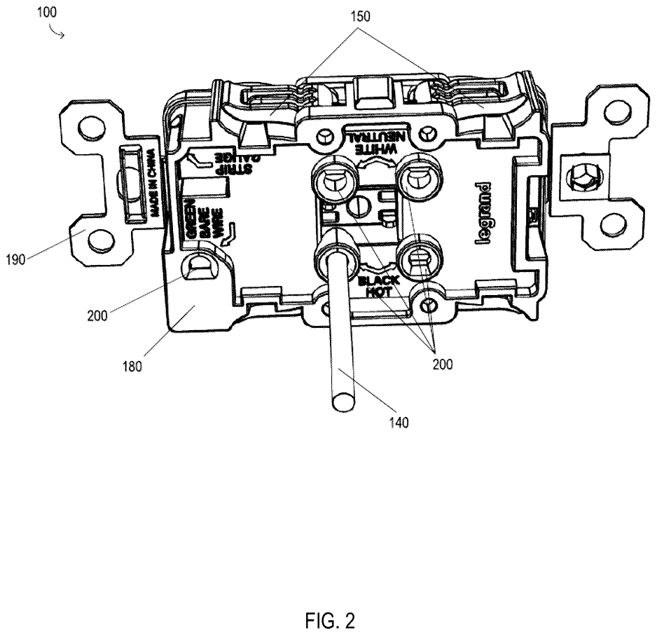

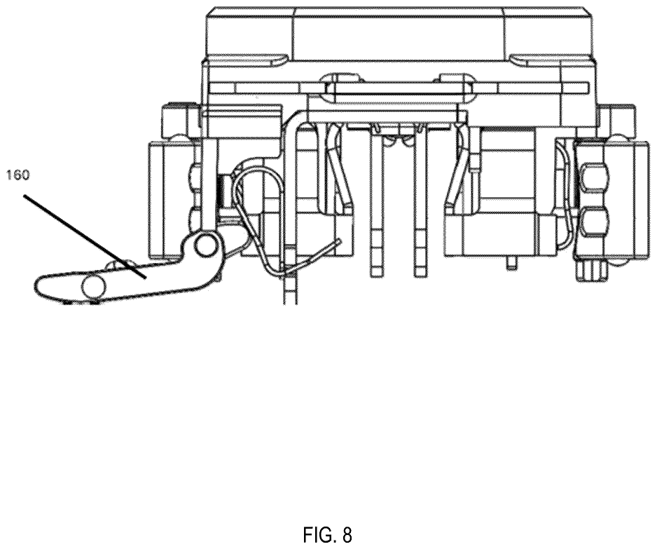

FIG. 2 shows a rear perspective view of an exemplary electrical wiring device 100. As shown, the rear portion of housing 180 can have a plurality of wire ports 200 capable of receiving wires 140. Each wire port 200 corresponds to a lever 150, 160, as appropriate and as shown. To install a wire 140, a lever 150, 160 (shown in the closed position/configuration in FIG. 2) is actuated to an open position/configuration (as shown in FIG. 8), compressing a wire retainer 170 (as shown in FIG. 8) to allow enough space in a gap (i.e., opening 240) of the wire retainer 170 for a wire to travel to the leads (not shown). A wire is then inserted into the corresponding wire port 200 and the lever 150, 160 is closed, decompressing the wire retainer 170, decreasing the gap in the wire retainer 170 to hold the wire 140 in place.

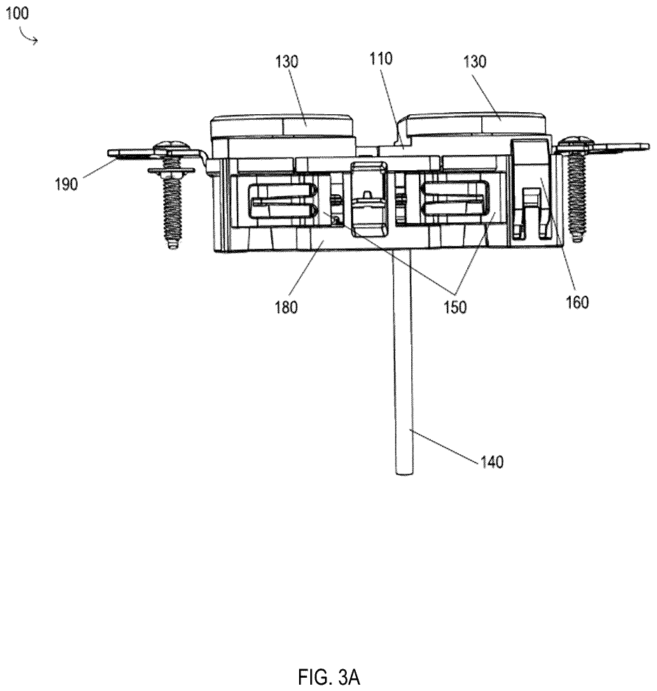

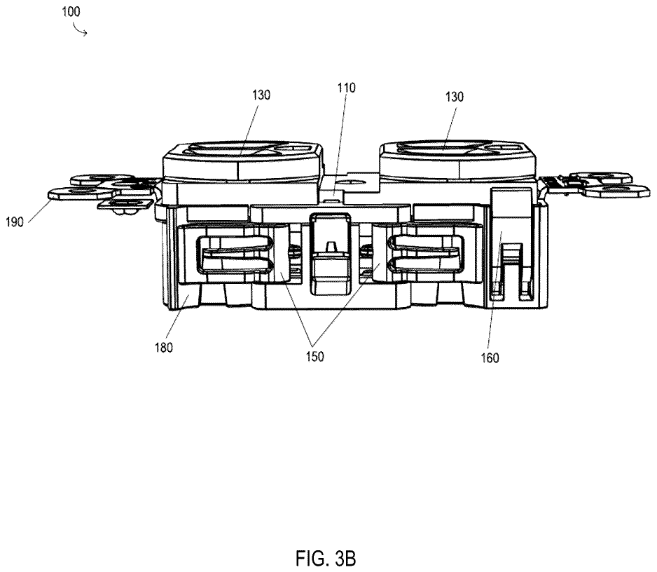

FIGS. 3A and 3B each show a side view of an exemplary electrical wiring device 100 with speed install levers 150, 160 in the closed position/configuration. As shown, the electrical wiring device 100 has a plurality of line/load, hot/neutral related levers 150 and a ground lever 160, though any suitable number and combination of levers may be used. The levers 150, 160 are disposed on a side face or surface of the housing 180 in a position that can be hidden inside a wall after installation. The electrical wiring device 100 may have conventional outlet receptacles 130 as shown, or may include other functionality/structure such as USB ports, switches, or other suitable receptacles on the cover 110 (as should be understood by a person of ordinary skill in the art in combination with a review of the disclosure). The electrical wiring device 100 can also have a conventional ground strap 190 for simple retrofit into existing installations.

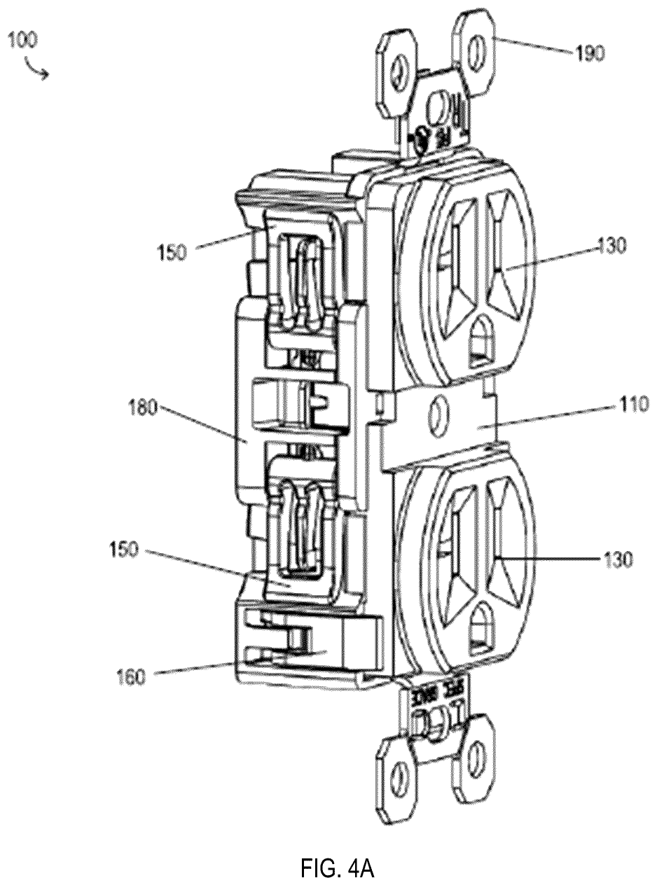

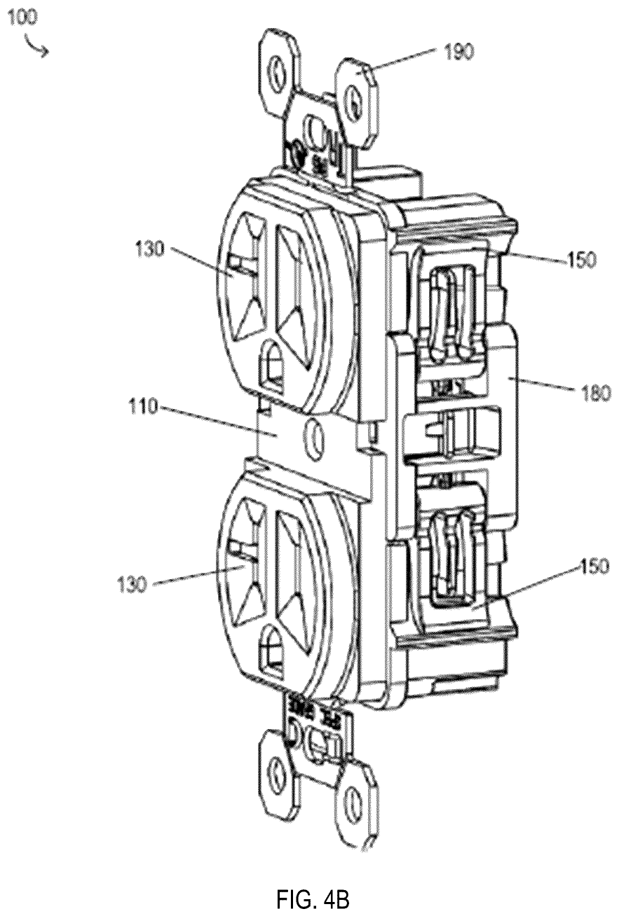

FIGS. 4A and 4B show perspective views of the sides of an exemplary electrical wiring device 100. The exemplary electrical wiring device 100 of FIGS. 4A and 4B has four levers 150 and one ground lever 160, though other combinations and number of levers 150, 160 are possible. As shown in FIG. 4A, one side of the housing 180 has two levers 150 and one ground lever 160. The ground lever 160 is shown in a perpendicular orientation to the neutral levers 150, though other suitable orientations and layouts of the levers 150, 160 are possible. The other side, as shown in FIG. 4B, has two levers 150. As shown in the closed position, the levers 150, 160 are flush or near flush with the housing 180 for simple installation into a wall box.

Turning briefly to FIGS. 10A-10B and 11A-11B, the levers 150, 160 have at least one protrusion 210 and a hinge 220. The levers 150, 160 are configured to rotate around the hinge 220 to actuate a wire retainer 170 with the protrusion 210.

As shown in FIG. 9, the wire retainers 170 are made of a continuous bent member. In some embodiments, the wire retainer 170 is made of high yield spring steel, though any suitable elastic material may be used. In an exemplary embodiment, the wire retainer 170 is in a round shape with one end extending past the other so the ends do not meet. One end of the wire retainer 170 has an opening 240 sized and shaped to allow a wire 140 to pass through the wire retainer 170. The opposing end of the wire retainer is sized and shaped with a protrusion 230 to be inserted into the end with the opening 240. In the neutral position (as shown), the protrusion 230 rests in the opening 240 near the opposing end of the wire retainer 170, keeping the wire 140 in place (not shown). When compressed by a lever, the end of the wire retainer 170 with the opening 240 translates away from the end with the protrusion 230, expanding the gap where the wire 140 is inserted, allowing for the wire 140 to be inserted or removed freely.

FIG. 5 shows a front cutaway view of inside an exemplary electrical wiring device 100. In this view, the cover (top housing portion) 110 and outlet receptacles 130 are hidden for clarity. As shown, each lever 150, 160 corresponds with a wire retainer 170. As shown in the closed position, the levers 150, 160 do not engage the wire retainers 170 which are in the neutral position. The wire retainers 170 are positioned within the housing with the end of the wire retainer 170 with an opening 240 positioned over a wire port 200 in the bottom of each wire retainer. In the neutral position, the wire retainer 170 holds the wire 140 in place on the terminals (not shown).

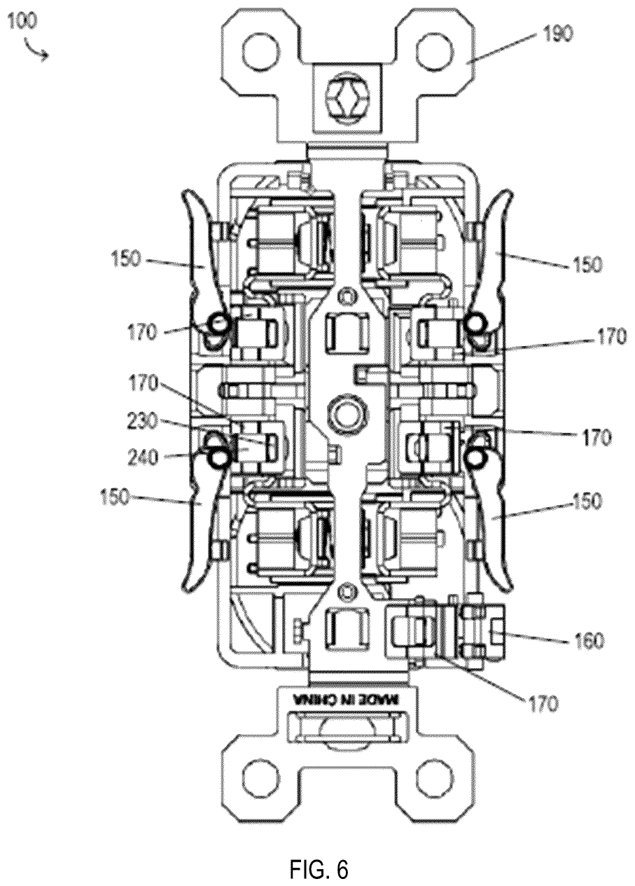

FIG. 6 shows a rear cutaway view of an exemplary electronic wiring device 100. In this view, the rear housing portion 180 is hidden for clarity. As shown, the levers 150, 160 are in the closed position and the wire retainers 170 are in the neutral (non-actuated) position. The openings 240 of the wire retainers 170 are aligned with the terminals (not shown) of the electrical wiring device 100. The protruding end 230 of the wire retainer 170 is flush or near flush with the opposing end of the wire retainer 170, creating tension to hold (via a spring bias force) a wire 140 positioned therein in place (when so positioned therein). While in the closed position as shown, the protrusion 210 on the levers 150, 160 does not engage the wire retainer 170.

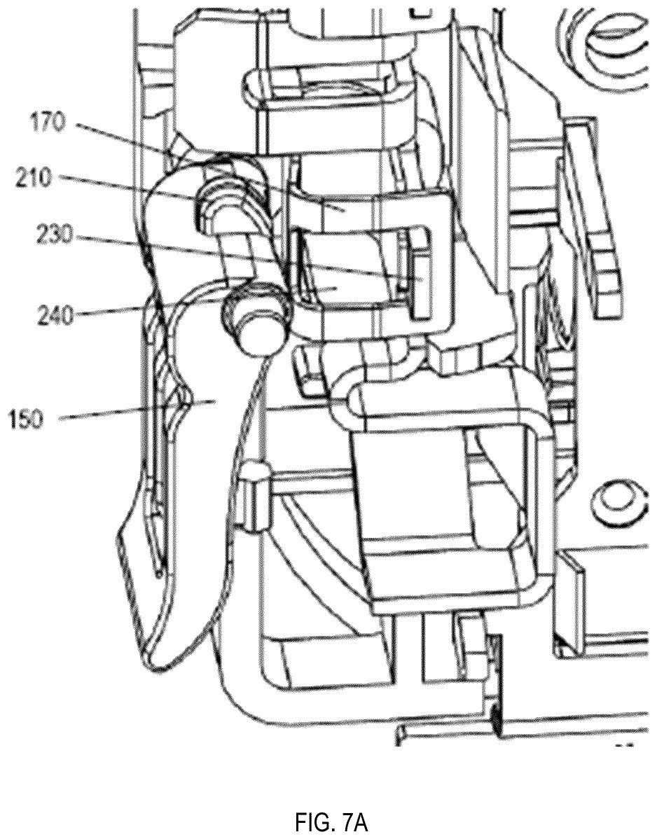

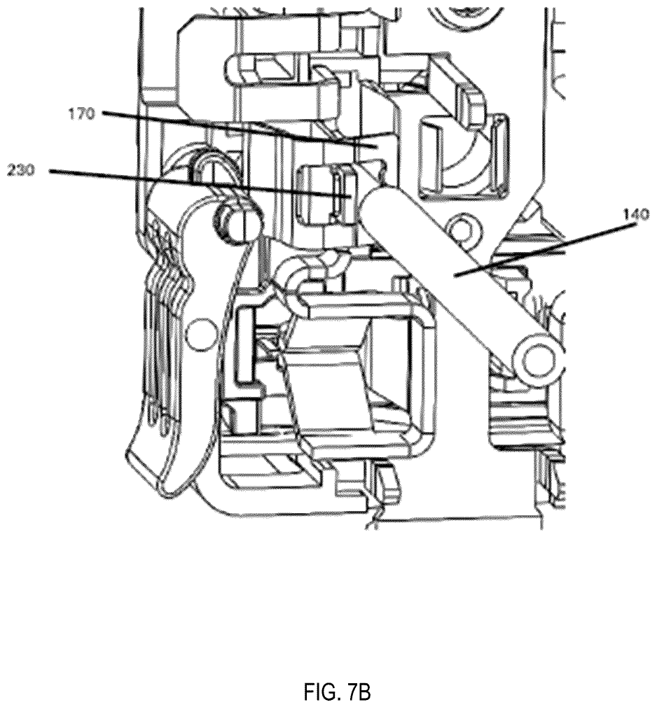

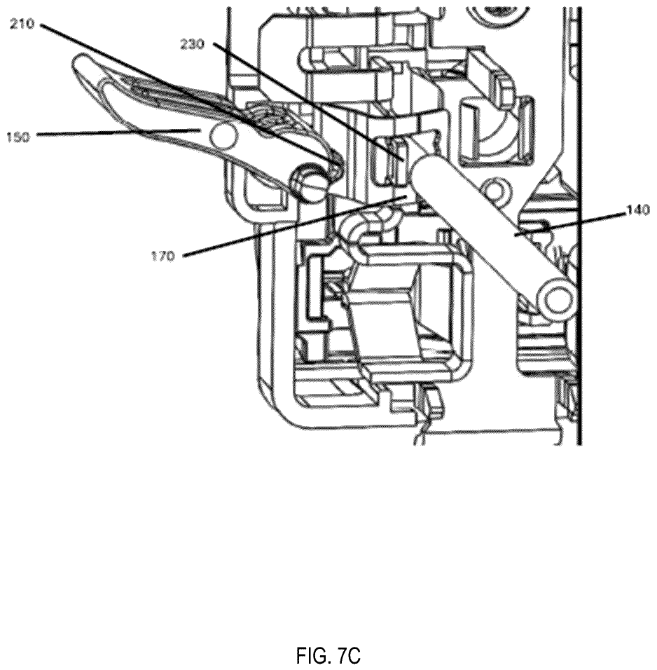

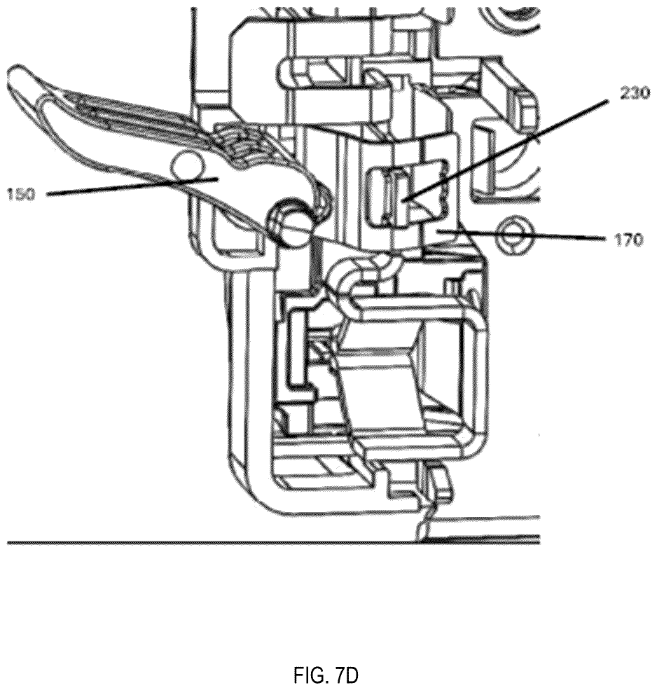

FIGS. 7A-7D show a close-up rear view of a lever 150 and wire retainer 170. As shown, the lever 150 is in the closed position and the wire retainer 170 is in the neutral position. In the closed position, the protrusion 210 on the lever does not engage the wire retainer 170. In the neutral position, the protrusion 230 on the wire retainer 170 is biased toward and flush or near flush with the opposing end of the wire retainer 170. The protrusion 230 holds the wire 140 (when positioned therein) in place against the opposing end of the wire retainer 170 while in the neutral position. FIG. 7B shows the same view as in FIG. 7A, with the addition of wire 140 positioned between an end of the wire retainer 170 and the protrusion 230 in the lever 150 closed position and configuration. FIG. 7B shows the same view as FIG. 7A, except with the lever 150 in the open position and the protrusion 210 acting on the wire retainer 170 to open the space between end of the wire retainer 170 and the protrusion 230 (FIG. 7C is the same as FIG. 7B, except the wire is removed). In other words, FIG. 7A depicts the closed position and configuration with the opening 240 (explained below) without a wire positioned therein, where the wire retainer 170 is biased to close on a wire and the opening 240 is reduced; FIG. 7B depicts the closed position and configuration with the wire retained within the opening 240; FIG. 7C depicts the open position and configuration with the wire positioned (and freely removable) within the opening 240 and the opening 240 is enlarged to accept the wire; and FIG. 7D depicts the open position and configuration with the opening 240 without a wire positioned therein.

FIG. 8 shows a close-up side view of a lever 160 in the open position and a wire retainer 170 in the compressed position. As shown, the protrusion 210 on the lever 160 engages with the wire retainer 170. As the lever 160 is opened, the protrusion 210 pushes the end of the wire retainer 170 with the opening 240 away from the end with the protrusion 230 (to the right, in the opposite direction of the spring bias). This increases the size of the opening 240 in the wire retainer 170 to allow for a wire to pass through the opening 240 for installation or removal.

By way of illustration, when looking at FIG. 9, the wire retainer 170 further comprises an inner cavity 135 and the opening 240. The wire retainer 170 is shown in a neutral position in FIG. 9 and in a compressed position in FIG. 8. While moving from the compressed position to the neutral position (neutral position shown in FIG. 9) (where the wire retainer 170 is biased in the neutral position), the inner cavity 135 is enlarged and the opening 240 is reduced (i.e., the protrusion 230 moves from left to right (referencing the direction and orientation in FIG. 9), creating a larger inner cavity and smaller opening). When moving from the neutral position to the compressed position (compressed position shown in FIG. 8), the inner cavity 135 is reduced and the opening 240 is enlarged (i.e., the protrusion 230 moves from right to left (referencing the direction and orientation in FIG. 9), creating a smaller inner cavity and larger opening). The enlargement of the opening 240 allows for a wire to be inserted therein, and once the wire retainer is returned to the neutral position, the opening 240 gets smaller and compresses and retains the wire therein.

By utilizing speed install levers 150, 160, wires 140 may be quickly, safely, and easily installed or replaced with an electrical wiring device 100 without tools.

FIGS. 9-11B depict various views of the wire retainer 170 and levers 150, 160.

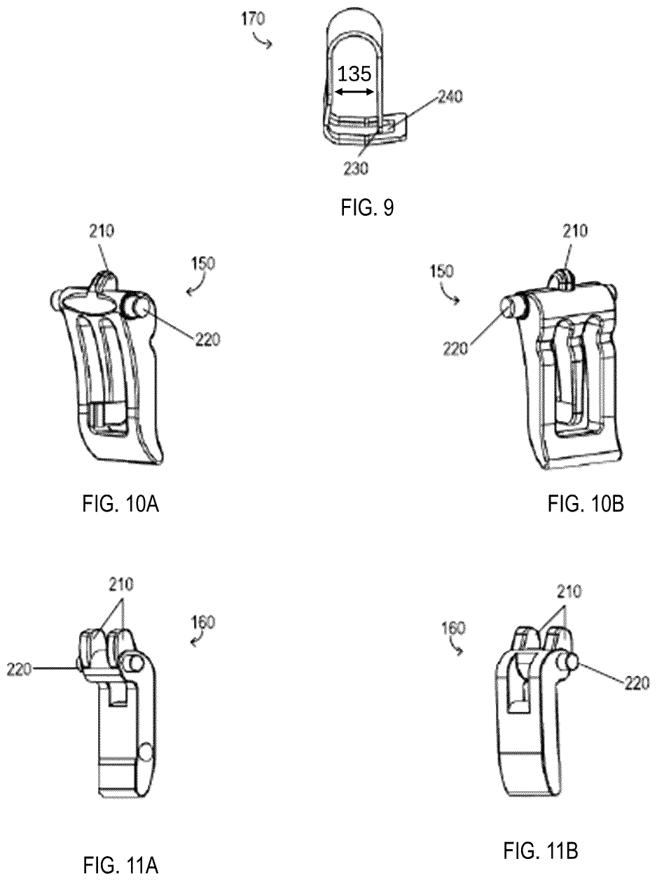

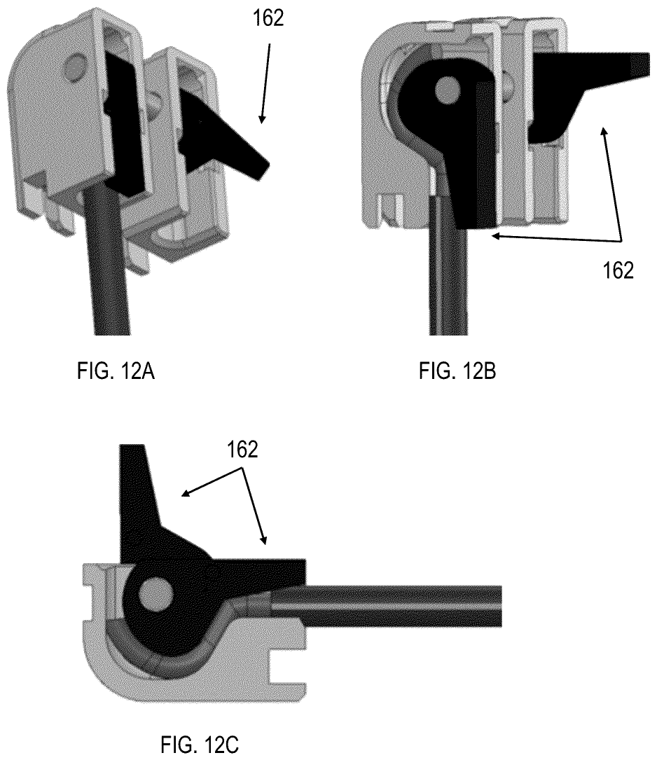

FIGS. 12A-18D refer to various latch mechanisms. Each of the alternative embodiments below can substitute for one or more of the latch mechanisms described above (as should be understood by a person of ordinary skill in the art in conjunction with a review of this disclosure). In a preferred embodiment, the embodiments described below are configured to replace the ground levers 160.

Referring to FIGS. 12A-12C, in this embodiment, a cam latch with a bend is shown. This embodiment advantageously has one or more cams 162 that can bend the wire when in the closed position (left side as shown in FIG. 12B) to increase retention therein. It can also provide tactile feedback to the user in order to know when the latch is in the closed position.

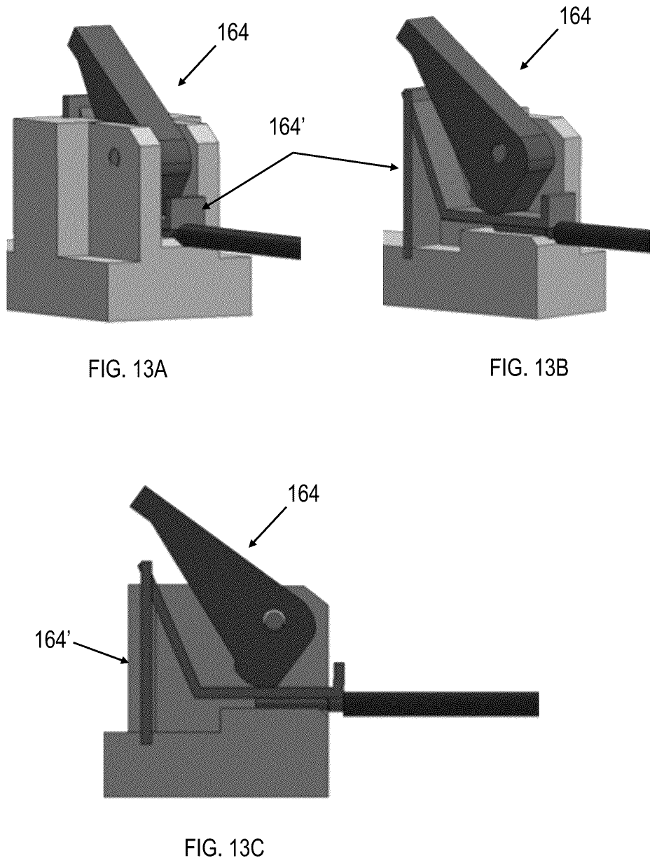

Referring to FIGS. 13A-13C, another embodiment is shown, wherein the cam 164 has a spring arm 164′. This advantageously provides a strong flat connection with a large contact surface. It can additionally adapt to any wire size. Similar to above, this embodiment can provide tactile feedback to the user.

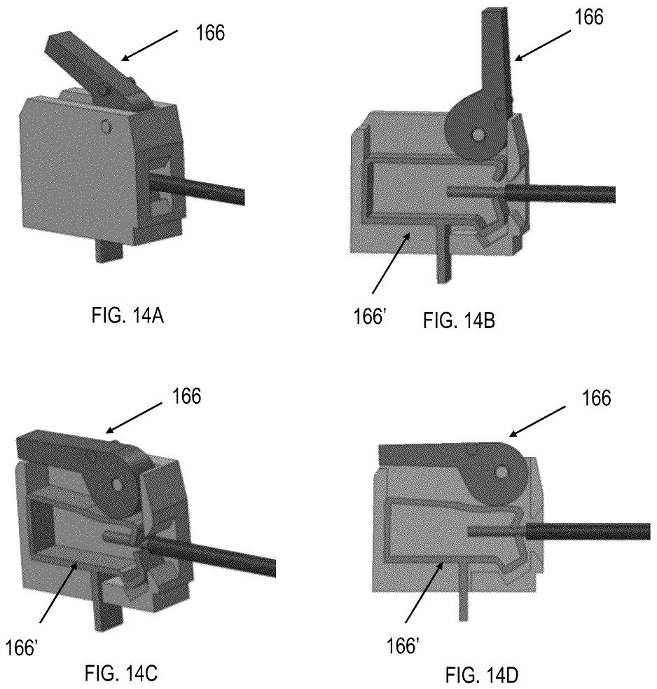

Referring to FIGS. 14A-14D, another alternative embodiment is shown with a spring and wire biting capabilities. This embodiment allows for flexibility, as it can be adaptable to accept a wire of different sizes. A user can insert the wire in the open position (see FIG. 14B), and once actuated to the closed position, the cam lever 166 suppresses the spring 166′ and secures the wire therebetween (see FIGS. 14C-14D). This design can advantageously reduce the risk of unwanted release of the wire. Similar to above, this embodiment can provide tactile feedback to the user.

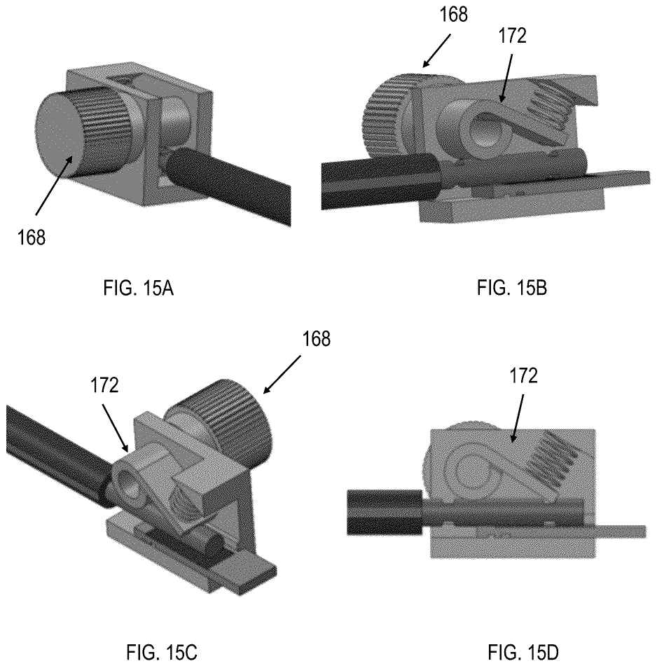

Referring to FIGS. 15A-15D, an embodiment featuring a knob with a preloaded spring is shown. This embodiment allows for flexibility and can adapt to accept wires of various sizes. Once the wire is inserted, the knob 168 can be turned to secure the cam lever 172 into a notch in the wire, thereby reducing the risk of unwanted release. Similar to above, this embodiment can provide tactile feedback to the user.

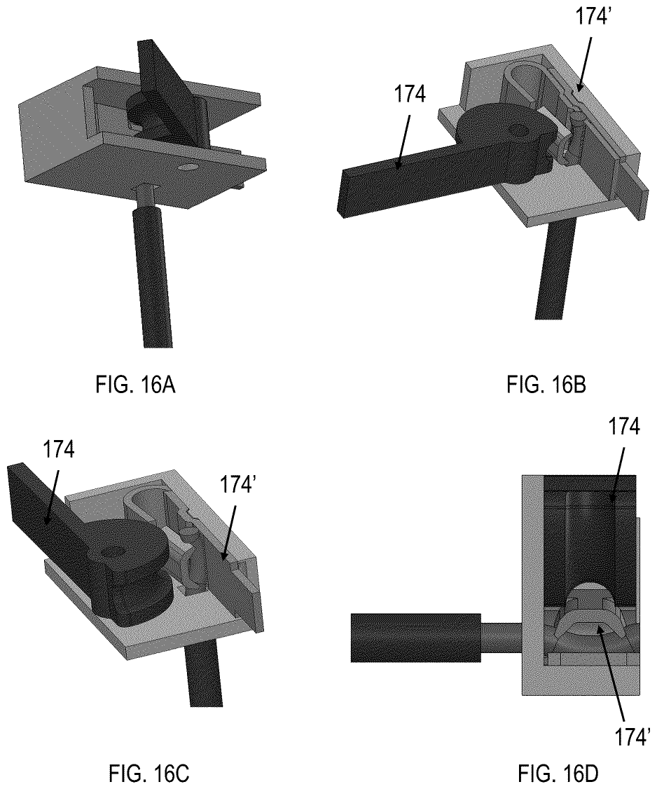

Referring to FIGS. 16A-16D, an embodiment with a cam actuated conductive spring is shown. This embodiment can also allow for flexibility and can adapt to accept wires of various sizes. Once the wire is inserted while in the open position (FIG. 16B), the cam lever 174 can be actuated to the closed position, compressing the spring 174′ against the wire, as shown (FIG. 16C-16D). This can reduce the risk of unwanted release. Similar to above, this embodiment can provide tactile feedback to the user.

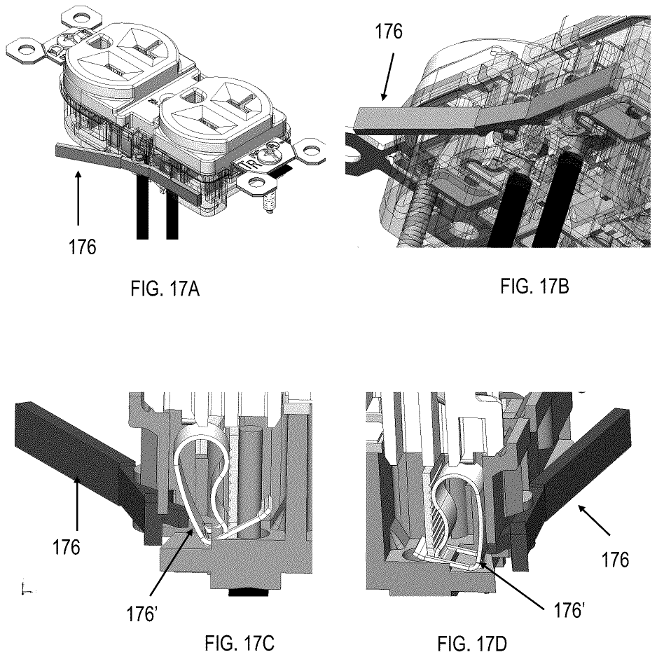

Referring to FIGS. 17A-17D, an embodiment with a paddle momentary press is shown. This embodiment can also allow for flexibility and can adapt to accept wires of various sizes. The paddle 176 can compress the spring 176′ to compress the wire, thereby reducing the risk of unwanted release. Similar to above, this embodiment can provide tactile feedback to the user.

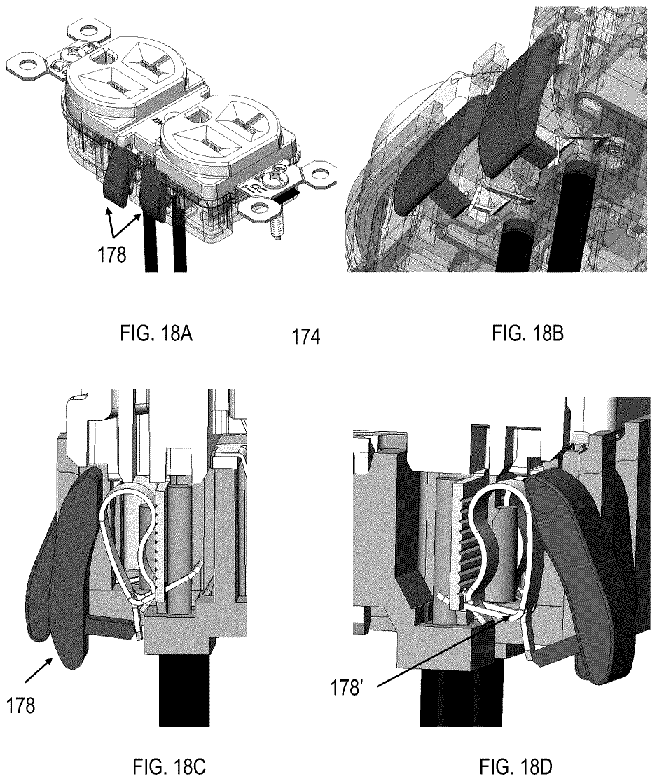

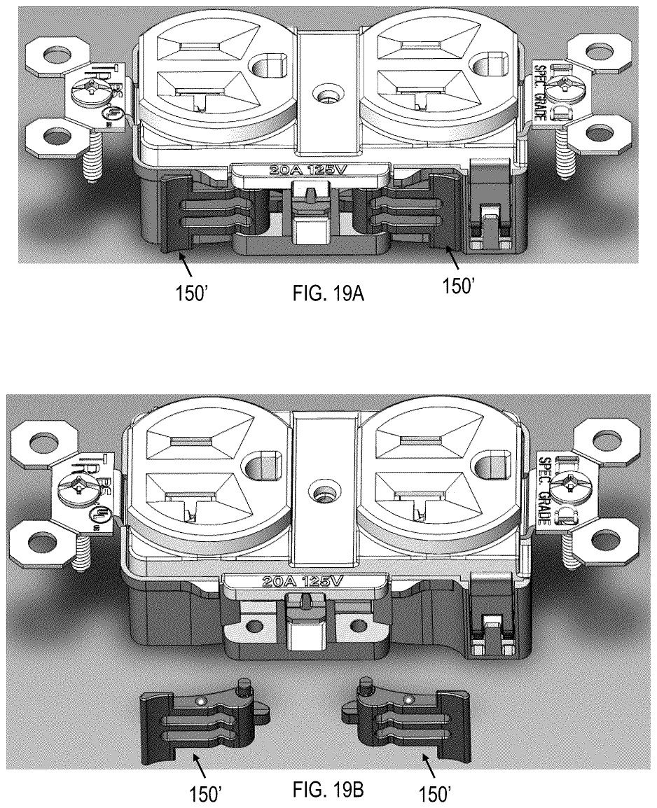

Referring to FIGS. 18A-18D, an embodiment featuring a lever momentary press is shown. This embodiment can similarly allow for flexibility and can adapt to accept wires of various sizes. One or more levers 178 can have a tail that compresses the internal spring 178′ which compresses the wire therein when moved to the closed position (see FIG. 18C). This advantageously can reduce the risk of unwanted release. Similar to above, this embodiment can provide tactile feedback to the user.

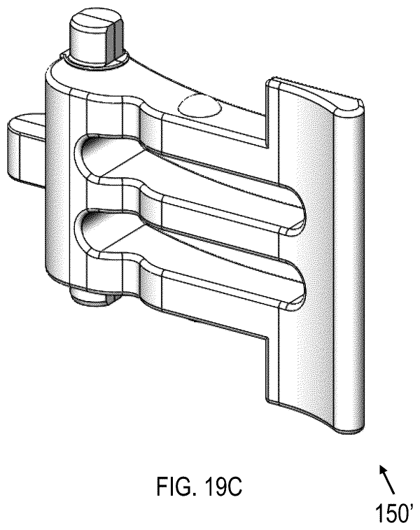

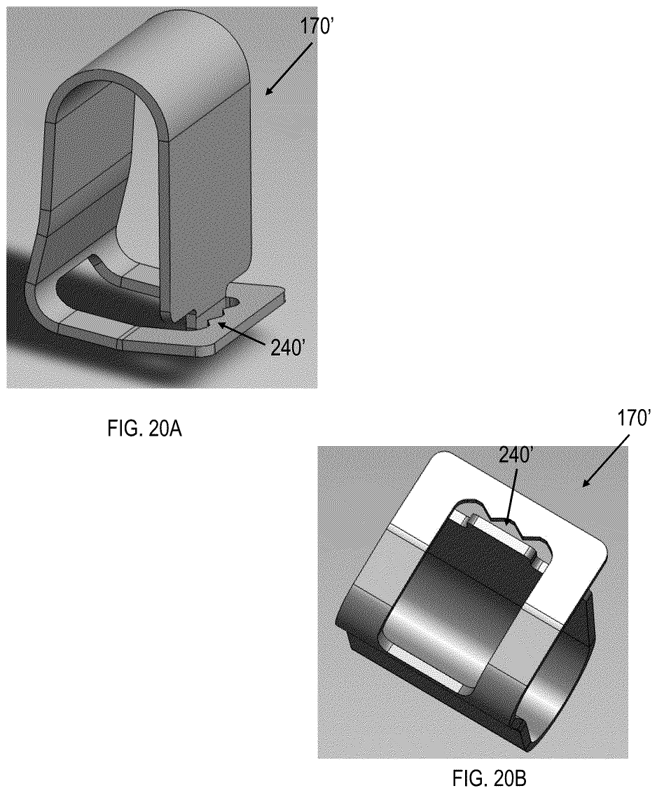

Referring to FIGS. 19A-19C, an alternative embodiment of the neutral lever 150′ is shown. This embodiment functions similarly to the neutral levers described above, but features a wing at its distal end. The wing can help the user engage the lever 150′ more easily and reduce the pressure they feel while opening the lever 150′.

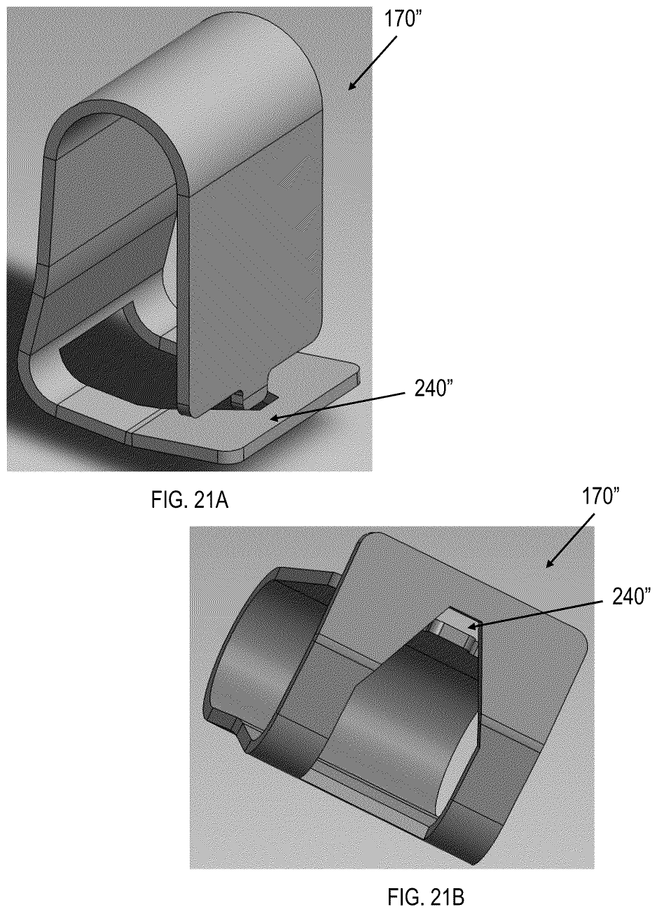

Referring to FIGS. 20A-21B, alternative embodiments of the wire retainer 170′ and 170″ are shown, respectively (in a neutral/home and unactuated position). These embodiments function similarly to the wire retainers described above, except in the embodiment shown in FIGS. 20A-20B, the opening 240′ features a set of teeth to provide additional contact on the wire. In the embodiment shown in FIGS. 21A-21B, the opening 240″ features a V-shape that also provides contact on the wire.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto; inventive embodiments may be practiced otherwise than as specifically described and claimed. All embodiments and elements thereof are intended to be combinable in any way mechanically possible.

All references, including publications, patent applications, and patents, cited herein are hereby incorporated by reference to the same extent as if each reference were individually and specifically indicated to be incorporated by reference and were set forth in its entirety herein.

All definitions, as defined and used herein, should be understood to control over dictionary definitions, definitions in documents incorporated by reference, and/or ordinary meanings of the defined terms.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

Approximating language, as used herein throughout the specification and claims, may be applied to modify any quantitative representation that could permissibly vary without resulting in a change in the basic function to which it is related. Accordingly, a value modified by a term or terms, such as “about” and “substantially”, are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

The recitation of ranges of values herein are merely intended to serve as a shorthand method of referring individually to each separate value falling within the range, unless otherwise indicated herein, and each separate value is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not impose a limitation on the scope of the invention unless otherwise claimed.

No language in the specification should be construed as indicating any non-claimed element as essential to the practice of the invention.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

It will be apparent to those skilled in the art that various modifications and variations can be made to the present invention without departing from the spirit and scope of the invention. There is no intention to limit the invention to the specific form or forms disclosed, but on the contrary, the intention is to cover all modifications, alternative constructions, and equivalents falling within the spirit and scope of the invention, as defined in the appended claims. Thus, it is intended that the present invention covers the modifications and variations of this invention provided they come within the scope of the appended claims and their equivalents.

What is claimed is:

1. An electrical wiring device comprising:
a housing formed of a front portion having a front surface and a rear portion having a rear surface, the housing further comprising at least two opposite side surfaces, each of which being positioned between the front surface and the rear surface, and an inner compartment;
an actuator positioned on one of the surfaces and movable between an open position and configuration and a closed position and configuration;
wherein when the actuator is in the open position and configuration, a wire is electrically connectable and removable from the electrical wiring device;
wherein when the actuator is in the closed position and configuration, the wire is locked in an electrically connected position and configuration with the electrical wiring device or is prevented from electrically connecting to the electrical wiring device; and
a spring disposed within the inner compartment and defining an inner cavity and an opening, wherein the spring is actuated via the actuator;
wherein when the actuator is moved from the open position and configuration to the closed position and configuration, the spring is moved from a compressed position in which the inner cavity is reduced and the opening is enlarged to a neutral position in which the inner cavity is enlarged and the opening is reduced;
wherein the spring is biased to the neutral position.

2. The electrical wiring device of claim 1, wherein the actuator comprises a lever hingedly connected to the housing and is configured to rotate on a hinge from the closed position and configuration to the open position and configuration.

3. The electrical wiring device of claim 1, wherein the opening is dimensioned to accept and selectively retain a wire therein.

4. The electrical wiring device of claim 3, wherein in the neutral position the spring is configured to hold the wire stationary.

5. The electrical wiring device of claim 3, wherein in the open position the spring is sized and shaped to allow the wire to pass through the spring.

6. The electrical wiring device of claim 1, wherein the lever is a ground lever.

7. The electrical wiring device of claim 1, wherein the lever is a neutral lever.

8. The electrical wiring device of claim 1, wherein the lever comprises a hinge and a first protrusion.

9. The electrical wiring device of claim 8, wherein the first protrusion is sized and shaped to engage the spring.

10. The electrical wiring device of claim 8, wherein the spring comprises a continuous bent member, the member comprises an opening on one end and a second protrusion on an opposing end; and
wherein the second protrusion is sized and shaped to fit within the opening.

11. The electrical wiring device of claim 10, wherein the end of the spring with the opening is configured to translate across the opposing end with the second protrusion.

12. The electrical wiring device of claim 1, wherein the spring is comprised of high yield spring steel.

13. The electrical wiring device of claim 1, wherein a surface of the lever is substantially flush with the housing in the closed position.

14. A method of using the electrical wiring device of claim 1, comprising the steps of:
moving the actuator from the closed position and configuration to the open position and configuration;
inserting the wire through a space defined by the opening; and
moving the actuator from the open position and configuration to the closed position and configuration, wherein a biasing force of the spring causes the spring to move to the neutral position and compress the wire therein.

15. The method of claim 14, wherein the actuator comprises a lever hingedly connected to the housing and is configured to rotate on a hinge from the closed position and configuration to the open position and configuration.

16. The method of claim 14, wherein in the neutral position the spring is configured to hold the wire stationary.

17. The method of claim 14, wherein the lever comprises a hinge and a first protrusion.

18. The method of claim 17, wherein the first protrusion is sized and shaped to engage the spring.

19. The method of claim 17, wherein the spring comprises a continuous bent member, the member comprises an opening on one end and a second protrusion on an opposing end; and
wherein the second protrusion is sized and shaped to fit within the opening.

20. The method of claim 14, wherein a surface of the lever is substantially flush with the housing in the closed position.
